(19) United States
(12) Patent Application Publication
(10) Pub. No.: US 2002/0011305 A1
(43) Pub. Date: Jan. 31, 2002

(54) Reinforced foil susceptor adhesive structure

(76) Inventors: Adam G. Malofsky, Loveland, OH (US); Bernard M. Malofsky, Bloomfield, CT (US); William H. Mann, Hopkinton, NH (US); Edward A. Reiss, Cincinnati, OH (US)

Correspondence Address: FROST BROWN TODD LLC, 2200 PNC Center, 201 East Fifth Street, Cincinnati, OH, 45202, US

(21) Appl. No.: 09/840,853

(22) Filed: Apr. 24, 2001

Related U.S. Application Data
(60) Provisional application No. 60/201,079, filed on Apr. 28, 2000.

(51) Int. Cl. B32B 7/02; B32B 31/00

(52) U.S. Cl. 156/275.7; 428/212

(57) ABSTRACT

Reinforced foil susceptor structures are disclosed. These structures are thin, allowing them to heat quickly when used in an induction heating process, but are also easy to handle and sturdy. The susceptor structures may comprise two foil layers (e.g., aluminum having a thickness of no greater than 2 mils) sandwiching between them a reinforcing layer (e.g., made from a thermoset or thermoplastic polymer), and having an induction activateable adhesive on one or both outer surfaces. In another embodiment, the susceptor structure comprise a single foil layer which carries a reinforcing layer on one or both of its outer surfaces, and an induction activateable adhesive on one or both of its outer surfaces. The method of joining articles using these susceptor structures is also disclosed.

This application is based upon and claims priority from U.S. Provisional Patent Application No. 60/201,079, Malofsky, et al., filed Apr. 28, 2000.

### TECHNICAL FIELD

The use of induction heating in combination with adhesives to bond surfaces is known. Traditional foil susceptors used for such operations are difficult to handle without tearing where the susceptors are soft, malleable, and thin. Handling difficulties are especially apparent where large amounts of materials are used, and especially large sheets or rolls of thin strips, such as for susceptor tapes. Aluminum is an excellent example of a susceptor material exhibiting such characteristics. For aluminum foils in particular, these susceptors are generally two (2) mils or less in thickness for fast heating times with lightweight, air cooled, low powered (2 KW and below) tools, but can be thicker (greater than 2 mils) where longer heating times are acceptable.

While certain types of reinforced susceptors have previously been used (see, for example, U.S. Pat. No. 5,717,191, Christensen, et al., issued Feb. 10, 1998; U.S. Pat. No. 5,500,511, Hansen, et al., issued Mar. 19, 1996; U.S. Pat. No. 5,508,496, Hansen, et al., issued Apr. 16, 1996; U.S. Pat. No. 5,705,795, Anderson, et al., issued Jan. 6, 1998; U.S. Pat. No. 5,705,796, Hansen, et al., issued Jan. 6, 1998; U.S. Pat. No. 5,723,849, Matsen, et al., issued Mar. 3, 1998; U.S. Pat. No. 5,756,973, Kirkwood, et al., issued May 26, 1998; U.S. Pat. No. 5,847,375, Matsen, et al., issued Dec. 8, 1998; U.S. Pat. No. 5,916,469, Scoles, et al., issued Jun. 29, 1999; U.S. Pat. No. 5,919,387, Buckley, et al., issued Jul. 6, 1999; and U.S. Pat. No. 5,919,413, Avila, issued Jul. 6, 1999), the described susceptors do not work well, if at all, for high speed bonding, especially for thin bond lines. These patents generally teach susceptors having a thickness of about 2 mils or greater, typically three (3) mils to ten (10) mils, that are coated on both sides with adhesive, and optionally include a second layer on either or both sides of a fiber reinforcement followed by another layer of continuous thermoplastic material. The final thickness of such a construction is at least 5 mils, more typically 10 mils or higher. While excellent for high performance, dynamic load-tolerant bonding of composite aerospace parts, the constructions are too thick, complicated, and expensive for use in all but specialized applications. Finally, the thickness of the susceptor, coupled with the thickness of the additional reinforcement and plastic layers, makes heating very inefficient. This inefficiency is particularly noticeable where fast heating times (less than about 10 seconds, more preferably less than about 2 seconds, and most preferably less than about 1 second) with lightweight, air cooled, low powered (2 KW and below) tools are desired. The operating conditions of most interest are those necessary for foil or mesh-based RF heating at frequencies less than about 40 mHz, more typically below about 1 mHz, most typically between about 1 kHz and about 500 kHz.

Reinforced thin metal sheets are also known for use as insulation materials (e.g., radiant heat barriers) and as sealing materials for medicine bottles. These materials are not used as susceptors for bonding operations and, therefore, do not include an electromagnetically activateable adhesive layer.

It would be of particular interest if a new susceptor that was thinner, more economical, and/or more efficient at heating the adhesive system or thermoplastics to be welded could be found. Such an innovation would be useful in a wide range of bonding applications, not just specialized ones, thereby allowing for improved bonding methods and fastener elimination in many industrial and consumer applications. However, such thin susceptors are extremely difficult to handle, tearing and folding easily. The following invention solves all of these problems with a thinner structure, at lower cost, and at higher heating efficiencies. The solution is especially effective for thin bond lines, and even more so for bonding where fast heating times (less than about 10 seconds, more preferably less than about 2 seconds, and most preferably less than about 1 second) with lightweight, air cooled, low powered (2 KW and below) tools are desired.

### SUMMARY OF THE INVENTION

The present invention relates to a susceptor article for use in electromagnetically-induced fastening, comprising two foil layers each of which has an inner and outer surface, and a reinforcing layer sandwiched between said inner surfaces, said susceptor article carrying an induction activateable adhesive on at least one of its outer surfaces.

The invention also relates to a susceptor article which comprises a foil layer having two outer surfaces, a reinforcing layer fastened to one or both of said outer surfaces and an induction activateable adhesive carried by one or both of said outer surfaces.

Finally, the invention relates to the method of fastening two target surfaces together wherein one of the susceptor articles, described above, is placed between and in contact with the two surfaces to be bonded, and is irradiated by electromagnetic energy thereby activating the adhesive.

### DETAILED DESCRIPTION OF THE INVENTION

The novel susceptor structure of the present invention is composed, at the minimum, of at least one layer of an electromagnetically activateable structure which produces heat via eddy current heating, hysteretic heating, or both, and which is fastened to a reinforcing layer. The susceptor structure also includes an induction activateable adhesive on one or both sides. The layers are held together by conventional adhesive materials. Examples of the electromagnetically activateable structure include foils made from aluminum, steel, or other metallic material, or non-metallic materials, such as specialized carbon or silicon. The term “structure,” as used herein, is meant to convey that the materials used can be formed with a specific purpose either related or unrelated to this invention. For example, the susceptor may be a thin sheet (foil), a thin sheet with perforations or holes, ordered or unordered, a thin mesh, and so on. The thickness of the susceptor structure surface may optionally be coated either wholly or partially with surface treatments of varying kinds, including primers, adhesives, coupling agents, and so on. The susceptor is typically less than about 2 mils, more preferably less than about 1 mil, and most preferably less than about 0.5 mil, thick.

The reinforcing layer can be made from any material that is not substantially electromagnetically activateable to produce heat, such that it provides improved strength to the new susceptor structure. Thermoplastic and thermoset polymer structures are typically utilized, optionally including some type of reinforcement that is isotropically strong. Examples of such an isotropic reinforcement are fibers, continuous or discontinuous, flakes, and the like, typically made from carbon, glass, olefin, aramid, boron, nylon, polyester, or cellulosic fibers, or combinations of these materials. The reinforcement may be in a continuous or discontinuous structure, and may be ordered (e.g., knit, cast, welded) or random (e.g., spun bonded). This layer is preferably less than about 10 mils, more preferably less than about 2 mils, and most preferably less than about 1 mil in thickness. Optional insulative materials and/or layers may be added to restrict thermal losses to the reinforcing layer.

The reinforcing layer will generally be non-metallic and is selected such that it increases the tear strength of the susceptor (when bonded to it) by at least a factor of about 2, preferably about 5, more preferably about 10, most preferably about 25. The reinforcing layer can be continuous or discontinuous, regular or irregular. Generally, the reinforcing layer will be in the form of a sheet, scrim or fibers (or combination thereof), which can be fastened to the susceptor by any method know in the art. The most common method is through the use of an adhesive, as long as that adhesive is not softened by the application of induction energy (otherwise the susceptor may fall apart during the fastening process). Frequently used reinforcing materials included organic polymers, inorganic polymers, fibers, papers and combinations thereof. Specific examples include olefinic polymers, polyesters, polyamides, polyurethanes, polyvinyls, and mixtures thereof. A preferred reinforcing material is polyethylene terphalate (PET). In some instances, the adhesive used to hold the susceptor article together can also act as the reinforcing layer.

The susceptor article may utilize a single susceptor sheet with a reinforcing layer on one or both of its sides, and an induction activateable adhesive on one or both of its sides. Similarly, the susceptor article may utilize a sandwich structure in which two (or more) susceptor sheets sandwich one (or more) reinforcing layers. In such a structure, one or both of the outer sides of the susceptor article carries an induction activateable adhesive.

Induction activateable adhesives are well-known in the art. Specifically, these adhesives undergo a chemical or physical reaction (such as melting) upon the addition of electromagnetic energy which causes them to bond to an adjacent surface. Specific embodiments of these adhesives are shown in the examples of this application. These adhesives will be applied to one or both of the outer faces of the susceptor article. They may be applied in a continuous or discontinuous, regular or irregular manner.

The article may consist of a single susceptor/reinforcing layer “sandwich” or may consist of multiple sandwich layers. The outer surfaces of the susceptor may carry a heat-activateable (induction activateable) adhesive to effect bonding to a target surface. One of the outer surfaces of the susceptor may have attached to it a material (e.g., decorative wood, wallpaper, fabric) which can be affixed to the target surface using the device of the present invention.

A key aspect of the present invention is that it provides thinner susceptors (e.g., about 5 mils or less, preferably about 3 mils or less) that can be bound with only one major reinforcement layer while simultaneously providing for direct contact of the adhesive system or structure or the weldable surface with the electromagnetically heatable susceptor structure. No prior art teaches or suggests such a structure. In fact, it is only in the packaging and insulating industries that one finds examples of somewhat similar structures for moisture barriers, reflective heat or cooling insulation, and cap-sealing materials.

The overall structures may be flat, textured, perforated, or any combination thereof. Either a portion or all of the susceptor structure can be reinforced. The reinforcement can vary in strength from one section to another. Changes are meant to facilitate handling, assembly of objects, or their disassembly. The structures may be utilized as sheets, discs, strips and so on, and may be stored as rolls, coils, or flat stacks.

In the method aspect of the present invention, the susceptor article of the present invention (particularly one having induction activateable adhesive on both of its outer surfaces) is placed between and in contact with two surfaces to be joined (i.e., one outer side of the susceptor article is in contact with each of the surfaces to be joined). The area to be fastened (i.e., the susceptor article) is then irradiated with electromagnetic energy, preferably having a frequency between 1 and about 1 mHz, most preferably from a hand-held tool, for from about 0.01 to about 10 seconds. The electromagnetic energy may be applied continuously or in pulses. This energy interacts with the susceptor to form heat energy which activates the adhesive, bonding the surfaces to be joined.

### EXAMPLES

| | |
|---|---|
| Susceptor Layer 1: | 0.25 mil aluminum foil, perforated or un- |
| | perforated, textured or untextured |
| Optional Surface | Adhesion promoter coating |
| Treatments: | Adhesion promoter primer coating |
| | Surface treatment to either or both sides of |
| | the aluminum, i.e., anodization, chemical |
| | etching |
| Optional Adhesive | To bond foil (layer 1) to reinforcement layer, |
| Layer 1 | i.e., a polyamide, polyester, or ethylene vinyl |
| | acetate-based film formulation. |
| Reinforcement | Polyester, nylon, polyamide, polyethylene, |
| Layer: | polybutylene, urethane , or other adhesive or |
| | polymeric cast resins, cured coatings, or |
| | films, 0.1 to 1.5 mils thick, perforated or un- |
| | perforated, textured or untextured (see |
| | below) |
| Optional Reinforcement | Continuous glass or other structural fibers or |
| Additions: | fiber bundles, positioned in an isotropic |
| | network spaced 1-2 cm apart in a square |
| | array within or laminated to the polymer |
| | film. |
| | A thin foam film 1-50 mils thick between |
| | two layers of polymeric film as an insulator |
| | to obviate thermal losses or to provide |
| | certain degrees of mechanical performance, |
| | i.e., cushioning or expansion/contraction |
| | load dissipation. |
| Optional Adhesive | To bond foil (layer 2) to reinforcement layer, |
| Layer 2 | i.e., a polyamide, polyester, or ethylene vinyl |
| | acetate based film formulation. |
| Susceptor Layer 2: | 0.25 mil aluminum foil, perforated or un- |
| | perforated, textured or untextured |
| Optional Surface | Adhesion Promoter coating |
| Treatments: | Adhesion Promoter Primer coating |
| | Surface treatment to either or both sides of |
| | the aluminum, i.e., anodization, chemical |
| | etching |
| Laminating Process: | The susceptor layers are laminated together |
| | using any number of adhesive systems that |
| | may consist of water-based, solvent-borne or |
| | other liquid polymer systems. Depending |
| | upon the system employed, drying or curing |
| | mechanisms may be required. These may |
| | include UV curing systems, IR or heat |
| | ovens. The adhesive layer thickness can be |
| | anywhere from a fraction of a mil (0.1 mil) |
| | to several mils in thickness. |
| | Laminating processes may include knife |
| | over roll, curtain coater, or in some cases a |
| | co-extrusion process can be employed using |
| | thermoplastic layers as the adhesive between |
| | the susceptors. |

What is claimed is:

1. A susceptor article for use in electromagnetically-induced fastening, comprising two foil layers each of which has an inner and outer surface, and a reinforcing layer which is sandwiched between said inner surfaces, said susceptor carrying an induction activateable adhesive on at least one of its outer surfaces.

2. The susceptor article according to claim 1 where the foil layers are fastened to the reinforcing layer.

3. The susceptor article according to claim 2 wherein the thickness of each foil layer is no greater than about 2 mils.

4. The susceptor article according to claim 3 wherein the foil layers are made from aluminum.

5. The susceptor article according to claim 4 wherein the reinforcing layer is selected from sheets, scrims, fibers and mixtures thereof.

6. The susceptor article according to claim 5 wherein the reinforcing layer is selected from organic polymers, inorganic polymers, fibers, papers and mixtures thereof.

7. The susceptor article according to claim 6 wherein the reinforcing layer is selected from olefinic polymers, polyesters, polyamides, polyurethanes, polyvinyls and mixtures thereof.

8. The susceptor article according to claim 7 wherein the reinforcing layer comprises polyethylene terphthalate.

9. The susceptor article according to claim 6 wherein the thickness of each foil layer is no greater than about 0.5 mil.

10. The susceptor article according to claim 3 having a total thickness of no greater than about 5 mils.

11. The susceptor article according to claim 6 which carries an induction activateable adhesive on both of its outer surfaces.

12. The susceptor article according to claim 6 which carries an induction activateable adhesive on one of its outer surfaces and carries a substrate to be fastened to a target surface on its other outer surface.

13. A susceptor article for use in electromagnetically-induced fastening, comprising a foil layer having two outer surfaces, a reinforcing layer fastened to at least one of said outer surfaces, and an induction activateable adhesive carried by at least one of said outer surfaces.

14. The susceptor article according to claim 13 wherein an induction activateable adhesive is carried by both of said outer surfaces.

15. The susceptor article according to claim 13 wherein the thickness of the foil layer is no greater than about 2 mils.

16. The susceptor article according to claim 15 where the foil layer is made from aluminum.

17. The susceptor article according to claim 16 wherein the reinforcing layer is selected from sheets, scrims, fibers and mixtures thereof.

18. The susceptor article according to claim 17 wherein the reinforcing layer is selected from organic polymers, inorganic polymers, fibers, papers and mixtures thereof.

19. The susceptor article according to claim 18 wherein the reinforcing layer is selected from olefinic polymers, polyesters, polyamides, polyurethanes, polyvinyls and mixtures thereof.

20. The susceptor article according to claim 19 wherein the reinforcing layer comprises polyethylene terphthalate.

21. The susceptor article according to claim 18 wherein the thickness of the foil layer is no greater than about 0.5 mil.

22. The susceptor article according to claim 13 having a total thickness of no greater than about 5 mils.

23. The susceptor article according to claim 13 having a reinforcing layer fastened to both of its outer surfaces.

24. The susceptor article according to claim 23 wherein an induction activateable adhesive is carried on both of its outer surfaces.

25. The susceptor article according to claim 23 wherein the thickness of the foil is no greater than about 2 mils.

26. The susceptor article according to claim 25 where the foil layer is made from aluminum.

27. The susceptor article according to claim 26 wherein the reinforcing layer is selected from sheets, scrims, fibers and mixtures thereof.

28. The susceptor article according to claim 27 wherein the reinforcing layer is selected from organic polymers, inorganic polymers, fibers, papers and mixtures thereof.

29. The susceptor article according to claim 28 wherein the reinforcing layer is selected from olefinic polymers, polyesters, polyamides, polyurethanes, polyvinyls and mixtures thereof.

30. The susceptor article according to claim 29 wherein the reinforcing layer comprises polyethylene terphthalate.

31. The susceptor article according to claim 28 wherein the thickness of the foil layer is no greater than about 0.5 mil.

32. The susceptor article according to claim 28 having a total thickness of no greater than about 5 mils.

33. The method of fastening two target surfaces comprising placing the susceptor article of claim 11 between said target surfaces, and irradiating said susceptor with electromagnetic energy having a frequency of from about 1 kHz to about 1 mHz for from about 0.01 to about 10 seconds.

34. The method of claim 33 wherein the electromagnetic energy is applied from a hand-held tool.

35. The method of fastening two target surfaces comprising placing the susceptor article of claim 14 between said target surfaces, and irradiating said susceptor with electromagnetic energy having a frequency of from about 1 kHz to about 1 mHz for from about 0.01 to about 10 seconds.

36. The method of claim 35 wherein the electromagnetic energy is applied from a hand-held tool.

37. The method of fastening two target surfaces comprising placing the susceptor article of claim 24 between said target surfaces, and irradiating said susceptor with electromagnetic energy having a frequency of from about 1 kHz to about 1 mHz for from about 0.01 to about 10 seconds.

38. The method of claim 37 wherein the electromagnetic energy is applied from a hand-held tool.
